(19) United States
(12) Patent Application Publication
(10) Pub. No.: US 2008/0310300 A1
(43) Pub. Date: Dec. 18, 2008

(54) Traffic Activity-Based Forwarding Table Updates For Ethernet-Based Mobile Access Networks

(76) Inventor: Byoung-Jo Kim, Morganville, NJ (US)

Correspondence Address: AT&T CORP., ROOM 2A207, ONE AT&T WAY, BEDMINSTER, NJ, 07921, US

(21) Appl. No.: 11/761,537

(22) Filed: Jun. 12, 2007

(51) Int. Cl. G08C 15/06

(52) U.S. Cl. 370/230

(57) ABSTRACT

A system and method for granting an association request from a mobile terminal, determining, during a predetermined time interval after granting the association request, if the mobile terminal has received traffic from a network and sent traffic to the network and sending a broadcast update packet to the network if it is determined that the mobile terminal has not both received traffic from and sent traffic to the network within the predetermined time interval.

### BACKGROUND

Wireless networks, of both large and small scales, are increasingly prevalent in the modern world. Such networks are developed for, and used by, both businesses and individuals.

One of the challenges present in designing and managing large-scale wireless networks with multiple base stations involves coordination of communications to and from mobile devices that move from one base station to another. A common example of such a device is a mobile telephone that is moving through its coverage area, with its connection being passed from one signal tower to another.

As a result of this type of movement, data that is being sent to a mobile device may be routed to the wrong base station, resulting in the need to use further bandwidth to forward such network traffic to the current base station. In some cases, data can even be lost entirely.

### SUMMARY OF THE INVENTION

A method for granting an association request from a mobile terminal, determining, during a predetermined time interval after granting the association request, if the mobile terminal has received traffic from a network and sent traffic to the network and sending a broadcast update packet to the network if it is determined that the mobile terminal has not both received traffic from and sent traffic to the network within the predetermined time interval.

A system having a network switch and a plurality of base stations, wherein, when a mobile terminal roams from a first of the plurality of base stations to a second of the plurality of base stations, the second of the plurality of base stations sends a broadcast update packet to the network bridge if no two-way traffic occurs to the mobile terminal within a predetermined time interval after the mobile terminal roams to the second of the plurality of base stations.

A method for determining, by a base station, whether traffic has been sent to and received from an associated mobile terminal during a predetermined time interval and sending, by the base station, a broadcast update packet to a network if the base station has determined that traffic has only been sent to the mobile terminal during the predetermined time interval.

A device having a memory storing a set of instructions and a processor executing the set of instructions, the set of instructions operable to grant an association request from a mobile terminal, determine, during a predetermined time interval after granting the association request, if the mobile terminal has received traffic from a network and sent traffic to the network and send a broadcast update packet to the network if it is determined that the mobile terminal has not both received traffic from and sent traffic to the network within the predetermined time interval.

A device having a memory storing a set of instructions and a processor executing the set of instructions, the set of instructions operable to determine whether traffic has been sent to and received from an associated mobile terminal during a predetermined time interval and send a broadcast update packet to a network if it is determined that traffic has only been sent to the mobile terminal during the predetermined time interval.

### DESCRIPTION OF THE DRAWINGS

FIG. 1 shows an exemplary system according to the present invention.

FIG. 2 shows an exemplary method for updating network forwarding tables according to the present invention.

FIG. 3 shows another exemplary method for updating network forwarding tables according to the present invention.

### DETAILED DESCRIPTION

The present invention may be further understood with reference to the following description and the appended drawings, wherein like elements are referred to with the same reference numerals. The exemplary embodiments of the present invention describe a system and methods for updating network forwarding tables. The exemplary embodiments ensure that network forwarding tables remain updated while minimizing the use of bandwidth for redundant updating. The exemplary system and methods will be discussed in detail below.

It is noted that the terms “base station” is used throughout this description to refer to a device that enables a mobile terminal to wirelessly access a data network. Furthermore, the terms “mobile terminal” and “mobile device” are used interchangeably to refer to any hardware device that may wirelessly access such a network (e.g., a mobile phone, a mobile computer, a personal digital assistant (“PDA”), etc.).

Many current and future wireless access networks are moving the wired portion of their networks toward Ethernet-based technologies. Such networks typically consist of a plurality of base stations (“BS”). Present networking standards use complicated tunneling techniques to support mobility when a terminal moves among various BS. Using Ethernet-based networks, however, such complexity can be removed without loss of performance.

This improvement is accomplished by the use of one of Ethernet's native characteristics, learned bridge forwarding, to direct user traffic to the correct BS by the implicit learning of ports where traffic source addresses appear. This is typically accomplished by a BS transmitting a broadcast update packet with a mobile terminal's source address into the wired Ethernet network, at the point when the mobile terminal is handed off to the BS, in order to update the learned bridge forwarding tables in one or more of the Ethernet switches comprising the access network.

If the mobile terminal is active, normal user traffic is often enough to update the necessary forwarding tables in the Ethernet bridges after handoff. However, this does not occur in all forwarding situations; therefore, using broadcast update packets (e.g., gratuitous Address Resolution Protocol (“ARP”) packets for networks operating under IPv4 or Neighbor Discovery (“ND”) mechanism packets for networks using IPv6) at the time of handoff is a reliable and commonly-used way to rapidly update bridge forwarding tables in an Ethernet-based network.

The use of broadcast update packets in this manner involves two drawbacks. First, the use of broadcast update packets causes an increase in the amount of traffic on the network. Second, numerous entries are made in the forwarding tables in Ethernet bridges that do not actually handle the traffic for a particular mobile terminal. Either of these may be the limiting factor on the size of an Ethernet-based mobile network. The exemplary embodiments of the present invention alleviate this issue by intelligently deciding whether such a broadcast packet is needed.

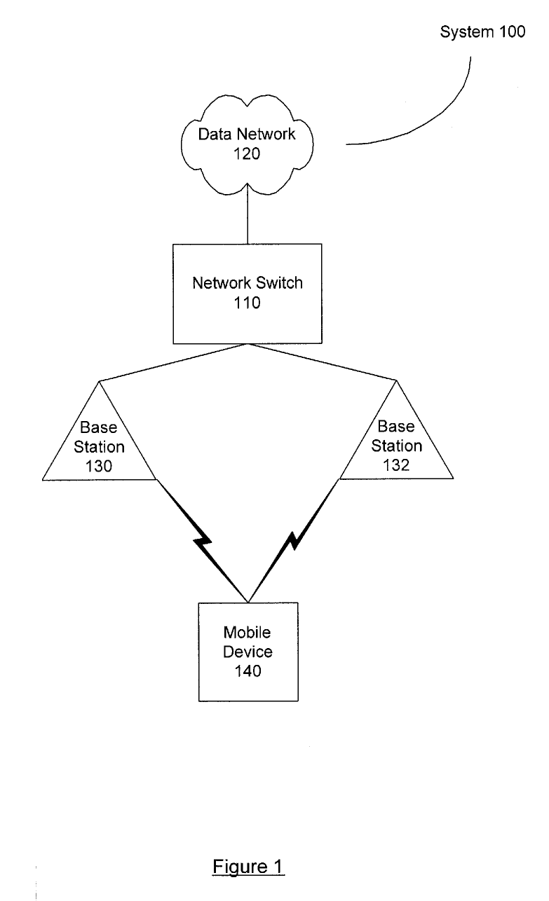

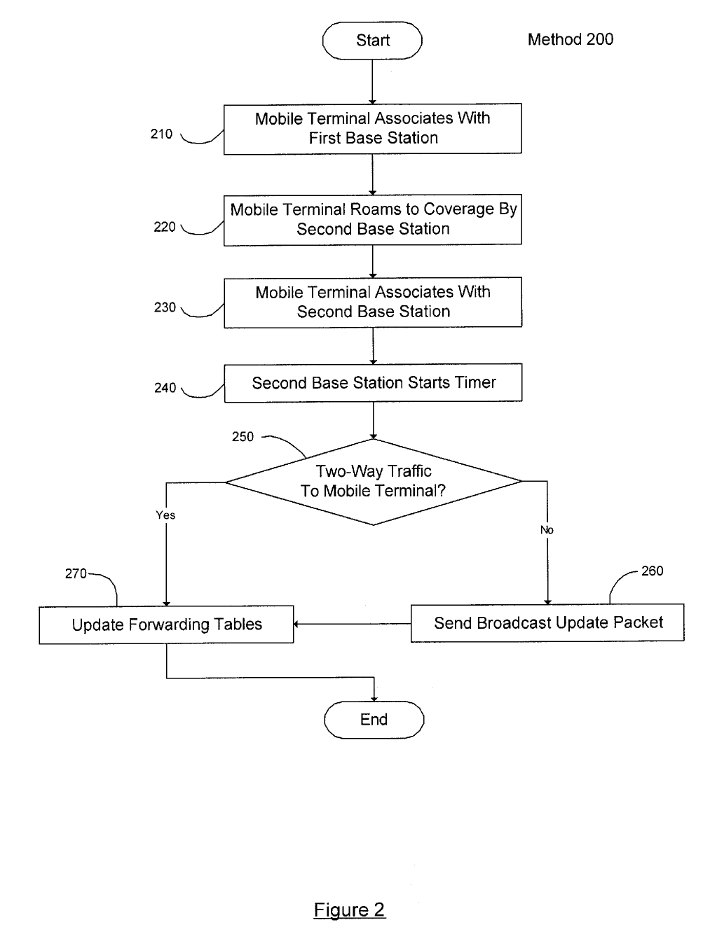

FIG. 1 shows an exemplary system 100 according to the present invention. The exemplary system 100 may act in accordance with the exemplary method 200 shown in FIG. 2. The system 100 includes at least one network switch 110 that is a component of a broader data network 120. The data network 120 may contain a plurality of network switches 110, with the precise number network switches 110 depending on the scale of the data network 120; however, for clarity, only one network switch 110 is shown in FIG. 1. The network switch 110 may be connected to the data network 120 via a wired Ethernet connection.

The network switch 110 may also be connected to a plurality of base stations 130, 132 via wired Ethernet connections. The base stations 130, 132 provide wireless connectivity for mobile devices. As for the network switch 110, the precise number of base stations 130, 132 present within the system 100 may vary depending on the size of the data network 120; for purposes of clarity, only two base stations 130, 132 are shown in FIG. 1.

One or more mobile terminals 140 may wirelessly interface with the data network 120 via the base stations 130, 132. As previously discussed, the mobile terminal 140 may be, for example, a mobile telephone, a mobile computer, a PDA, etc. Those of ordinary skill in the art will understand that the number of mobile terminals 140 communicating with the data network 120 may vary depending on factors including the specific implementation of the data network 120, the time of day, the day of the week, etc. If the data network 120 is a cellular telephone network, for example, there may be thousands of mobile terminals 140 in communication with the data network 120 through various base stations 130, 132 at any given point in time.

In the first step 210 of exemplary method 200, a mobile terminal 140 forms a communications link with a first base station 130. Step 210 may be, for example, the initiation of a telephone call by the user of mobile terminal 140 in an implementation wherein mobile terminal 140 is a mobile phone. In step 220, the mobile terminal 140 roams to an area covered by a second base station 132 of the system 100. Such roaming will typically correspond to a physical relocation of the user of the mobile terminal 140, such as by walking or driving. In step 230, the mobile terminal 140 reassociates with the second base station 132; this is also referred to as the mobile terminal 140 being “handed over” to the second base station 132.

In step 240, the second base station 132 initiates a countdown timer. The timer is typically set within a range of several seconds to tens of seconds, and is fine-tuned using measurements made during normal operations as a tradeoff between broadcast updates and encapsulated forwarding or dropped packets due to outdated forwarding tables. Once the timer expires, in step 250 the base station 132 determines whether, while the timer was pending, the mobile terminal 140 exchanged any two-way traffic with the data network 120 through the base station 132. If, in step 250, the base station 132 determines that no two-way traffic has been exchanged, then the method proceeds to step 260, wherein the base station 132 sends a broadcast update packet, as described above, to the wired data network 120. After step 260, the method proceeds to step 270 (described below). If, however, it is determined in step 250 that two-way traffic has been exchanged between the mobile terminal 140 and the data network 120 via the base station 132, the method proceeds directly to step 270 without performing step 260.

Ethernet learned bridging forwarding relies fundamentally on two-way traffic, since it updates forwarding tables based on the source address of received packets and the port at which it observes the receipt of such packets. Thus, any normal two-way traffic to and from the mobile terminal 140 after handoff is sufficient to update all necessary bridge tables for any existing connections; ARP/ND process, a normal part of IP operation, handles any new connections. Accordingly, any amount of normal two-way traffic to and from the mobile terminal 140 is sufficient for the method to proceed from step 250 to step 270, as described above, without sending the broadcast update packet in step 260.

In step 270, the forwarding tables in the data network 120 (i.e. in the network switch 110) are updated to reflect that the mobile terminal 140 is now communicating with the data network 120 via the second base station 132 rather than the first base station 130. This enables the proper routing of network traffic to the mobile terminal 140, and is part of the normal operation of switched Ethernet.

The first base station 130, which the mobile terminal 140 has roamed away from, forwards any buffered packets or in-transit packets that it receives to the second base station 132. This forwarding may be, for example, by MACinMAC, IP tunneling, VLAN, MPLS, etc. These are not considered “native” communications and do not affect the above-described method.

Most packet traffic is two-way in nature, so in most handoff instances the sending of a broadcast packet in step 260 will be unnecessary. However, if the base station 132 observes only one-way traffic to the mobile terminal 140 (e.g., a data download by mobile terminal 140), tunneled traffic from the previous base station 130, or no traffic at all, there is a risk that inconsistent forwarding tables will be present in some Ethernet bridges. This risk is corrected by sending out a broadcast update packet, as in step 260.

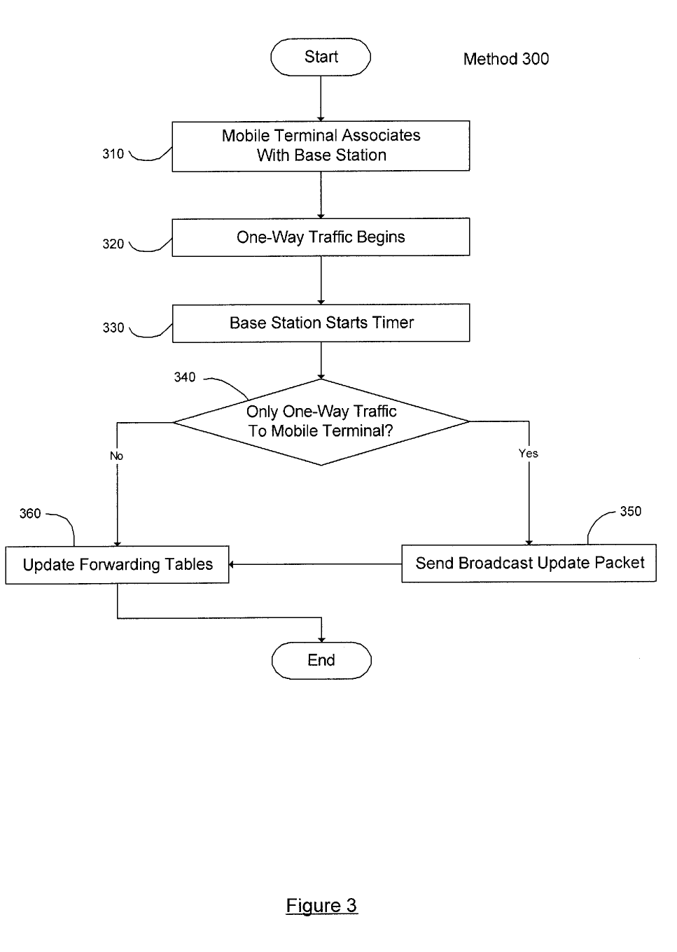

In another exemplary embodiment, the system 100 follows the steps of exemplary method 300, shown in FIG. 3. In step 310, the mobile terminal 140 associates with one of the base stations 130, 132 in a manner described above. For clarity of language, this exemplary method will assume that the mobile terminal is associated with the base station 130. Association in step 310 may be, for example, in one of the manners described above, such as by initiating communications with the base station 130 or by being handed off to the base station 130 from another base station (e.g., base station 132) while roaming during ongoing communications. In step 320, one-way traffic from the data network 120 to the mobile terminal 140 begins. One-way traffic may be, for example, downloading of data to mobile terminal 140.

In step 330, the base station 130 initiates a countdown timer, similar to that described above with reference to step 240 of exemplary method 200. This timer is typically set to half the length of the forwarding table aging timers in the network. The default (and, therefore, most common) value of the aging timer is 300 seconds; as a result, the most common length of the timer initiated in step 330 is 150 seconds. Once the timer expires, in step 340 the base station 130 determines whether, while the timer was pending, the mobile terminal 140 solely continued receiving one-way traffic from the data network 120 through the base station 130. If, in step 340, the base station 130 determines that traffic during the timed period has been solely one-way to the mobile terminal 140, then the method proceeds to step 350, wherein the base station 130 sends a broadcast update packet, as described above, to the wired data network 120. After step 350, the method proceeds to step 360. If, however, it is determined in step 340 that upstream traffic from the mobile terminal 140 to the data network 120 via the base station 130 has also occurred during the timed period, the method proceeds directly to step 360 without performing step 350.

In step 360, the forwarding tables in the data network 120 (i.e. in network switch 110) are updated to reflect that the mobile terminal 140 continues to be associated with the base station 130. This enables the proper routing of network traffic to the mobile terminal 140. Unlike the above exemplary method 200, which facilitates proper routing of network traffic to a mobile terminal 140 that has roamed from one of the base stations 130, 132 to another, the exemplary method 300 serves to maintain proper routing of network traffic to a mobile terminal 140 that has remained associated with the same base station 130 despite the fact that a network switch 110 may purge the forwarding entry for the mobile terminal 140 after a period of time has elapsed due to a lack of packets received from the mobile terminal 140.

The exemplary embodiments of the present invention prevent forwarding table inconsistencies in Ethernet-based mobile access networks. Moreover, they do so without the overhead of sending broadcast update packets at every handoff event, and without unnecessary increase in the sizes of forwarding tables in switches that are not handling the traffic for a particular mobile terminal.

As a result, such Ethernet-based networks can be deployed on larger scales. Separate IP subnets are required less frequently, and IP layer mobility can be handled with MIP or other tunneling methods.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
granting an association request from a mobile terminal;
determining, during a predetermined time interval after granting the association request, if the mobile terminal has received traffic from a network and sent traffic to the network; and
sending a broadcast update packet to the network if it is determined that the mobile terminal has not both received traffic from and sent traffic to the network within the predetermined time interval.

2. The method of claim 1, wherein the predetermined time interval is between 1 second and 200 seconds.

3. The method of claim 1, wherein the mobile terminal is one of a mobile telephone, a mobile computer and a PDA.

4. The method of claim 1, wherein the network includes an Ethernet bridge.

5. The method of claim 1, wherein the base stations are cellular phone towers.

6. The method of claim 1, wherein the method is performed by a wireless base station.

7. The method of claim 1, wherein the association request is received from the mobile terminal when the mobile terminal is roaming from a wireless base station.

8. A system, comprising:
a network switch; and
a plurality of base stations,
wherein, when a mobile terminal roams from a first of the plurality of base stations to a second of the plurality of base stations, the second of the plurality of base stations sends a broadcast update packet to the network bridge if no two-way traffic occurs to the mobile terminal within a predetermined time interval after the mobile terminal roams to the second of the plurality of base stations.

9. The system of claim 8, wherein the predetermined time interval is in the range between 1 second and 200 seconds.

10. The system of claim 8, wherein the predetermined time interval is adjustable based on the performance of the system.

11. The system of claim 8, wherein the mobile terminal is one of a mobile telephone, a mobile computer and a PDA.

12. The system of claim 8, wherein the network switch is an Ethernet bridge.

13. The system of claim 8, wherein the base stations are cellular phone towers.

14. A method, comprising:
determining, by a base station, whether traffic has been sent to and received from an associated mobile terminal during a predetermined time interval; and
sending, by the base station, a broadcast update packet to a network if the base station has determined that traffic has only been sent to the mobile terminal during the predetermined time interval.

15. The method of claim 14, wherein the predetermined time interval is between 1 second and 200 seconds.

16. The method of claim 14, wherein the mobile terminal is one of a mobile phone, a mobile computer and a PDA.

17. The method of claim 14, wherein the network bridge is an Ethernet bridge.

18. The method of claim 14, wherein the base station is a cellular phone tower.

19. A device, comprising:
a memory storing a set of instructions; and
a processor executing the set of instructions, the set of instructions operable to,
grant an association request from a mobile terminal;
determine, during a predetermined time interval after granting the association request, if the mobile terminal has received traffic from a network and sent traffic to the network; and
send a broadcast update packet to the network if it is determined that the mobile terminal has not both received traffic from and sent traffic to the network within the predetermined time interval.

20. A device, comprising:
a memory storing a set of instructions; and
a processor executing the set of instructions, the set of instructions operable to,
determine whether traffic has been sent to and received from an associated mobile terminal during a predetermined time interval; and
send a broadcast update packet to a network if it is determined that traffic has only been sent to the mobile terminal during the predetermined time interval.
